(19) United States
(12) Patent Application Publication
(10) Pub. No.: US 2026/0117871 A1
(43) Pub. Date: Apr. 30, 2026

(54) V-PACKING UTILIZING POLYARYLETHER KETONE SEAL ELEMENTS

(71) Applicant: Weatherford Technology Holdings, LLC., Houston, TX (US)

(72) Inventor: Preston N. WEINTRAUB, Spring, TX (US)

(73) Assignee: Weatherford Technology Holdings, LLC, Houston, TX (US)

(21) Appl. No.: 18/932,224

(22) Filed: Oct. 30, 2024

Related U.S. Application Data
(60) Provisional application No. 63/713,527, filed on Oct. 29, 2024.

(51) Int. Cl. F16J 15/3232; F16J 15/3284

(52) U.S. Cl. CPC F16J 15/3232; F16J 15/3284

(57) ABSTRACT

A seal assembly comprising a first back-up ring, a second ring member, and a plurality of v-rings arranged in a stacked configuration and interposing the first back-up ring and the second ring member. The at least one of the plurality of v-rings being a v-seal formed from a material that comprises a polyarylether ketone (PAEK), the material having a tensile modulus equal to or less than 3,900 MPa at room temperature.

### CROSS-REFERENCE TO RELATED APPLICATIONS

This application claims priority to and the benefit of U.S. Provisional Application 63/713,527 filed on Oct. 29, 2024, and entitled “V-packing Utilizing Polyarylether Ketone Seal Elements.” The aforementioned application is incorporated by reference herein.

### FIELD OF THE DISCLOSURE

The present disclosure relates generally to a V-packing sealing system of a downhole tools, subsea systems, and surface equipment (e.g., pumps), and more particularly, to a V-packing sealing system that uses seal elements (e.g., v-seals) formed from a polyarylether ketone (PAEK), such as polyether ether ketone (PEEK).

### BACKGROUND OF THE DISCLOSURE

Downhole tools often include components and/or chambers separated by (or in some cases, protected by) seal assemblies or seal assembly systems. Exposure to extreme pressures and temperatures may negatively affect the functionality of these seal assemblies and/or systems.

Conventional seal assemblies include seal members that are formed from a polymer that includes perfluoroalkyl/polyfluoroalkyl (PFAS) materials, such as polytetrafluoroethylene (PTFE) commonly known as Teflon®. PFAS are commonly referred to as “forever chemicals” and are widely known to be long-lasting and harmful to both people and the environment.

There is a need in the art for a seal assembly capable of withstanding high pressures and temperatures that reduces or eliminates the amount of PFAS materials that is placed in the environment. In other words, there is a need for a sealing system that uses more environmentally friendly materials.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a seal assembly comprises a first back-up ring, a second ring member, and a plurality of v-rings arranged in a stacked configuration and interposing the first back-up ring and the second ring member. The at least one of the plurality of v-rings being a v-seal formed from a material that comprises a polyarylether ketone (PAEK), the material having a tensile modulus equal to or less than 3,900 MPa at room temperature.

According to an embodiment consistent with the present disclosure, a seal assembly comprises a first back-up ring, a second ring member, and a plurality of v-shaped rings arranged in a stacked configuration and interposing the first back-up ring and the second ring member. Each v-shaped ring being formed from a material comprising a polyarylether ketone (PAEK) that is devoid of perfluoroalkyl/polyfluoroalkyl (PFAS).

According to an embodiment consistent with the present disclosure, a seal assembly comprises a first back-up ring, a second ring member, and a plurality of v-shaped rings arranged in a stacked configuration and interposing the first back-up ring and the second ring member. Each v-shaped ring being formed from a material comprising a polyarylether ketone (PAEK that is devoid of both perfluoroalkyl/polyfluoroalkyl (PFAS) and polytetrafluoroethylene (PTFE).

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a partial sectional view of a workstring that may embody or otherwise employ one or more principles of the present disclosure.

FIG. 2A is a partial sectional view of an example seal assembly depicted in FIG. 1, that may embody or otherwise employ one or more principles of the present disclosure.

FIG. 2B is a partial sectional view of another example of the seal assembly depicted in FIG. 1, that may embody or otherwise employ one or more principles of the present disclosure.

FIG. 3 is a partial sectional view of another example of the seal assembly depicted in FIG. 1, that may embody or otherwise employ one or more principles of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure relate generally to a v-packing sealing system that can be used with downhole tools, subsea systems, and surface equipment (e.g., pumps), and more particularly, to a v-packing sealing system that includes seal elements (e.g., v-seals) formed from polyarylether ketone (PAEK) materials, such as being formed from a polyether ether ketone (PEEK).

V-packing sealing systems (or v-ring seal assemblies) are currently utilized in downhole tools used to explore and develop oil and gas fields. V-ring seal assemblies are particularly useful in generating seals in extreme pressure and temperature environments. However, conventional v-ring seal assemblies utilize “forever” chemicals (e.g., PFAS) that do not readily break down once introduced into the environment. The v-ring seal assembly disclosed herein is comprised of material(s) that enable forming a robust seal while reducing and/or eliminating the use of forever chemicals.

While the exemplary embodiment described herein are shown in the context of a downhole tool located in a downhole environment, the seal assemblies described herein are applicable to subsea system (e.g., risers, wellheads, etc.) and surface equipment (e.g., pumps, wellheads, etc.).

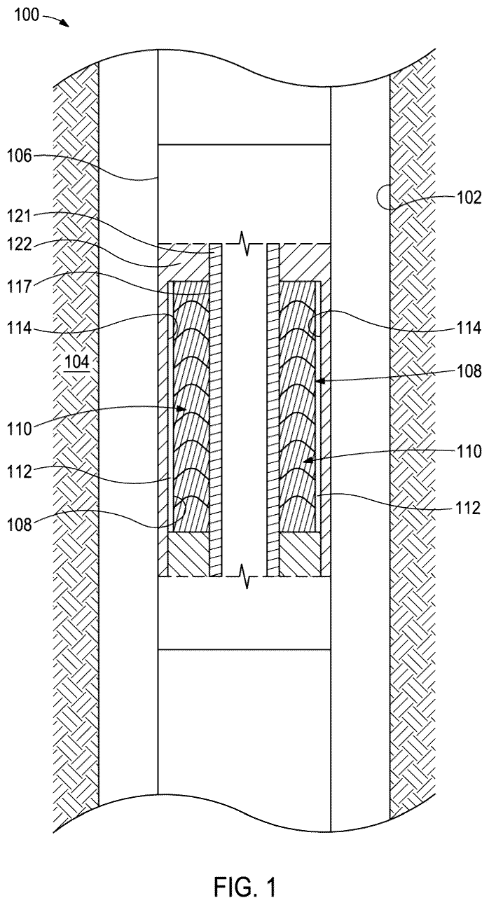

FIG. 1 is an enlarged schematic diagram of a partially exposed portion of an example workstring 100 disposed (extended) within a wellbore 102, according to one or more principles of the present disclosure. In the present embodiment, the wellbore 102 may be disposed with a formation 104 that exhibits a reservoir pressure (pore pressure) that meets or exceeds 25,000 psi. The formation 104 may also have temperatures reaching up to 450° F. In other embodiments, the formation 104 may exhibit pressures that may be more than or less than 25,000 psi. In other embodiments, the formation 104 may exhibit temperatures greater than or less than 450° F.

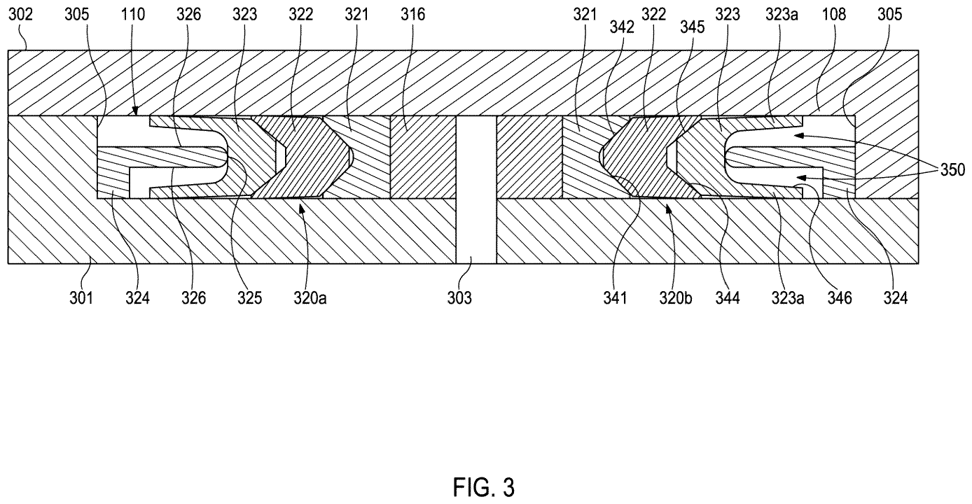

The workstring 100 may include one or more downhole tools 106 (one shown) operable to perform one or more operations within the wellbore 102. The downhole tool 106 may include one or more annular cavities or “glands” 108 (one shown) configured to receive and retain a seal assembly 110. The seal assembly 110 may be operable to generate and maintain a seal and/or barrier with the gland 108. In some embodiments, the gland 108 may be defined within the body of the downhole tool 106, such as being formed by multiple distinct components of the downhole tool 106. More specifically, the gland 108 may be defined within the side walls of the downhole tool 106, extending circumferentially about (through) the downhole tool 106. In other embodiments such as FIG. 1 and as shown in FIG. 3, a first tubular (or component) 121 with a first diameter may be disposed within a second tubular (component) 122 with a second, larger diameter, thereby defining the gland 108 between the outer diameter of the first tubular 121 and inner diameter of the second tubular 122 configured to receive and retain the seal assembly 110. In such embodiments, the seal assembly 110 may be arranged to provide a seal between the first and second tubulars 121, 122. In either of the aforementioned embodiments, the gland 108 may be sized as necessary in order to receive the seal assembly 110. In some embodiments, a clearance gap 112 may be present between the seal assembly 110 and a sidewall 114 (e.g., inner surface of the second tubular 122) of the downhole tool 106. While not shown, a similar clearance gap may be present between the seal assembly 110 and an inner surface 117 (e.g., outer surface of the first tubular 121). The seal assembly 110, when energized, closes the clearance gap(s) and seals against the sidewall 114 and the inner surface 117.

The seal assembly 110 may be positioned within the downhole tool 106 for a variety of reasons. In some embodiments, the downhole tool 106 may include internal sensors (not shown), disposed within its interior body that are incapable of withstanding the formation 104 pressures and/or temperatures. Accordingly, the seal assembly 110 may be arranged to prevent the pressure and/or high temperature fluid from reaching the internal sensors. In other embodiments, the seal assembly 110 may be configured to prevent pressure and/or fluid from passing above or below the seal assembly 110. In some embodiments, the seal assembly 110 may be configured to allow fluid flow in one direction while blocking fluid flow in the opposite direction. Accordingly, the seal assembly 110 disclosed herein may be used for any desirable purpose that may or may not be disclosed herein.

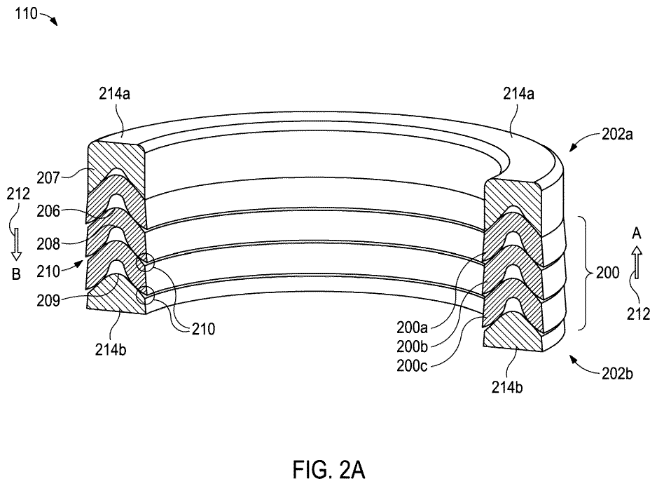

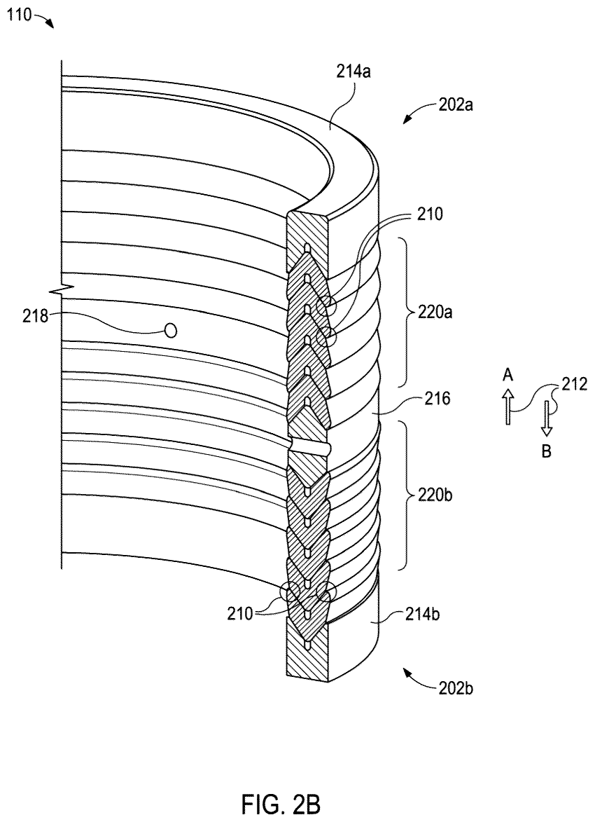

FIG. 2A is a partial sectional view of an example seal assembly 110 in accordance with the principles of the present disclosure. The seal assembly 110 may be positionable within the gland 108 (FIG. 1) of the downhole tool 106 (FIG. 1). As shown, the seal assembly 110 includes a plurality of stacked v-rings, shown as v-rings 200a, 200b, and 200c, and first and second back-up rings 214a and 214b positioned at respective first (upper) end 204a and second (lower) end 204b of the seal assembly 110. As illustrated, the v-rings 200a-c axially interpose the back-up rings 214a,b (e.g., ring members). Those of ordinary skill may recognize the seal assembly 110 described herein as a “vee-packing.”

In the example embodiment shown in FIG. 2A, the seal assembly 110 includes a stack of three v-rings 200a-c, but the stack could alternatively include more than three or less than three rings, such as at five rings as shown in FIG. 2B. Accordingly, the number of v-rings 200a-c included within the seal assembly 110 may be at the discretion of the downhole tool 106 manufacturer and/or dependent on the application of the downhole tool 106 in which the seal assembly 110 may be included.

The v-ring 200a-c are generally circular (e.g., ring members) and have the same or similar outer diameter. The v-rings 200a-c are each sized to be positioned within the gland 108 (FIG. 1). The v-rings 200a-c are operatively coupled to each other by positioning (stacking) the v-rings 200 atop one another and thereby forming a stack. As shown, each v-ring 200a-c may have a chevron (e.g., v-shaped) cross-section, wherein each v-ring 200a-c includes a top surface that is convex in shape, thereby forming a peak 206. For example, the v-rings 200a-c may each be a chevron packing as shown in FIG. 2A. The bottom surface of each v-ring 200a-c (surface opposite of the peak 206) comprises a groove 208 that is concave in shape. The seal assembly 110 may be assembled so that the peak 206 of each respective v-ring 200a-c may be positioned within the groove 208 of the axially adjacent v-ring 200a-c. Each v-ring 200a-c further includes a pair of opposing sides that define at flanged ends 210. In operation, the flanged ends 210 may protrude outwardly into the clearance gap 112 (FIG. 1) due to radial expansion of the v-ring and may fit or conform to any malformation or irregularity that existing within the gland 108 itself.

In some embodiments, and as shown in FIG. 2A, every v-ring 200a-c is a v-seal (e.g., a seal element, chevron packing element). In other words, every v-ring 200a-c is a compliant seal element designed to sealingly engage a surface of the gland 108 to block fluid communication. The seal assembly 110 depicted in FIG. 2A is uni-directional, wherein the peaks 206 and flanged ends 210 of each v-ring 200a-c are positioned in the same axial direction. Depending on the operations, a fluid 212 may be circulated through or about the downhole tool 106 (FIG. 1) thereby contacting the flanged ends 210. Fluid 212 flow in direction A causes the fluid 212 to come into contact with the exterior flanged ends 210, which causes flanged ends 210 of the v-rings 200a-c to radially expand (e.g., flex radially outward) to form a tight seal between the respective v-ring 200a-c and the surface that the v-ring 200a-c is sealing against. In other words, fluid 212 flow in direction A causes the v-rings 200a-c to open and seal against a surface of the gland 108 to block fluid flow. Additionally, the shape and stacking of the v-rings 200a-c between the backup rings 214a,b facilitates radial expansion of the v-rings 200a-c. For example, pressure acting on the flanged end 210 of the third v-ring 200c trapped between the lower back-up ring 214b and second v-ring 200b causes the flanged end 210 to radially expand into sealing contact with the gland 108. The pressure acting on the third v-ring 200c causes the causes the peak 206 of the v-ring 200c to wedge (e.g., press) against the second v-ring 200b that is trapped between the first v-ring 200a and the third v-ring 200c, which cause the flanged end 210 of the second v-ring 200b to radially expand into contact with the gland 108. The second ring 200b similarly causes the first ring 200a to radially expand as the peak 206 of the second ring 200b is wedged against the first v-ring 200a that is trapped between the second v-ring 200b and the upper back-up ring 214a, causing the flanged end 210 of the first v-ring 200a to flare outward into contact with the gland 108. Thus, the third v-ring 200c may be the primary seal while first v-ring 200a and second v-ring 200b are redundant secondary seals. Compression and radial expansion of the v-rings 200a-c creates a tight seal between the seal assembly 110 and the outer diameter of the gland 108 (e.g., sidewall 114 in FIG. 1) and the inner diameter of the gland 108 (e.g., the inner surface 117).

Fluid 212 flow in direction B (referred to as “flow by”) forces the flanged ends 210 of v-rings 200a-c radially inward, essentially “closing” the seal assembly 110 to allow fluid to flow past the v-rings 200a-c in the direction B. In such an example, the seal assembly 110 acts as a check-valve by allowing fluid flow in direction B, but substantially preventing fluid flow in the opposite direction A.

Similar to the v-rings 200a-c, the upper and lower back-up rings 214a,b may also be generally chevron or v-shaped rings. The v-seal rings 200a-c are compressed between the back-up rings 214a,b in response to fluid flow in direction A which acts, in part, on the lower back-up ring 214b. The back-up rings 214a,b are a stiffer component than the v-rings 200a-c which facilitates the radial expansion of the v-rings 200a-c into a sealing engagement. In the example embodiment, the upper back-up ring 214a is considered female in that one (e.g., the top) surface of the upper back-up ring 214a is generally flat and a second (e.g., bottom) surface defines a groove 207 operable to receive the peak 206 of the axially adjacent (upper-most) v-ring 200a. In contrast, the lower back-up ring 214b is male, wherein a first (bottom) surface is generally flat and a second (top) surface provides or defines a peak 209 sized to be positioned (received) within the groove 208 an axially adjacent (e.g., the lower-most) v-ring 200c. Fluid flow in direction A forces the peak 209 of the lower back-up ring 214b into the groove 208 of the third ring 200c, and thereby causing the flanged end 210 of the third ring 200c to radially expand, which, in turn, facilitates the expansion of the second ring 200b and first ring 200a. Inclusion of the back-up rings 214a,b may enable the seal assembly 110 to withstand increased pressures and temperatures. The back-up rings 214a,b may limit or prevent extrusion (migration) of the v-rings 200a-c beyond their designed and intended purpose, such as being sized to limit the space (e.g., annulus) between the surface of the gland 108 and back-up ring available for a v-ring to extrude into during use. In addition, the back-up rings 214a,b support the v-rings and provide durability to the seal assembly 110. In some embodiments, upon installation of the seal assembly 110 within the gland 108 (FIG. 1), the back-up rings 214a, b may cover (e.g., close) the clearance gaps (e.g., clearance gap 112 FIG. 1), such as the back-up rings 214,b each abutting opposing surfaces on opposite sides (e.g. sidewall 114 and inner surface 117).

In addition to the chevron shape of the v-rings 200a-c and the back-up rings 214a,b, the particular material of the v-rings 200a-c and the back-up rings 214a,b substantially contributes to forming a robust seal. More specifically, materials that are compliant are a desirable seal element material since the seal element needs to be deformable while also being biased toward a radially expanded state to maintain and/or form a seal against a sealing surface (e.g., surface of the gland 108). Compliant materials have a low tensile modulus and a low flexural modulus as compared to non-compliant materials. Additionally, ductility is a desirable quality of a seal element material, since ductile materials have reduced stiffness and increased elongation (e.g., the amount of stretch a material may exhibit when subjected to tensile force or strain) before failure. In other words, ductility is desirable since ductile materials can flow (e.g., deform) and while conforming to a surface of the gland 108. In addition, materials comprising low coefficients of friction are similarly desirable to reduce wear at the interface between the components of the seal assembly 110 and force in dynamic applications.

For this reason, v-packing seal assemblies currently used within the industry generally include v-rings made of a combination of polytetrafluoroethylene (PTFE) and other perfluoroalkyl/polyfluoroalkyl (PFAS) chemicals. PFAS have a low Modulus of Elasticity, low tensile modulus, and are generally more ductile. Thus, forming conventional v-rings formed from PFAS materials provides a v-ring that deforms and extrudes as designed to sealingly engage with a surface. Moreover, both PTFE and PFAS exhibit desired compliance characteristics and are considered durable at downhole pressures. However, PFAS are widely known as “forever chemicals” and do not readily break down in the environment. PFAS also have temperature limitations, such as having undesirable sealing qualities at certain wellbore temperatures, such as becoming undesirably extrudable at certain temperatures. Additionally, PFAS are susceptible to abrasion by particles in the fluid interacting with the v-ring which limits the durability and longevity of v-rings formed from PFAS. A seal assembly that negates the use of PFAS while providing a durable and robust seal is desirable.

According to embodiments of the present disclosure, the v-rings 200a-c may be comprised entirely of polyarylether ketone (PAEK) material, such as polyether ether ketone (PEEK), thereby completely eliminating PFAS materials. While those of ordinary skill may be familiar with PAEK and PEEK, such as PEEKs use in combination with PTFE in the manufacture of some back-up rings 214a,b (i.e., PTFE-filled PEEK), PAEK has not been used in the manufacture of the v-seal rings 200a-c. Without being bound by theory, it is believed that PEAK's properties (e.g., strength, hardness, and stiffness), as well as cost, have contributed to persons of ordinary skill in the art overlooking PAEK as a viable material for v-ring seals in v-packing sealing assemblies. More specifically, those of ordinary skill may have understood PEAK as having undesirable compliance characteristics (e.g., Modulus of Elasticity and Tensile Modulus) for v-seals as compared to other compounds such as PTFE. However, the material properties of some compositions of PAEK have been found to have suitable compliance characteristics to provide a robust and durable seal that is also advantageously resistant to abrasion as compared to PTFE and elastomers. Additionally, some compositions of PAEK, in addition to providing a desirable seal, are also preferable because of their resistance to corrosive materials and potential use in high temperature environments, such as above 350° F. For example, PAEK has desirable seal qualities at temperatures where seals made of elastomers fail and PTFE flows and extrudes to failure. Additionally, PAEK avoids the environmental concerns associated with PFAS.

According to embodiments disclosed herein, the v-rings 200a-c may comprise a specialty PAEK, such as a specialty PEEK, with a lower tensile modulus (reduced stiffness) and increased elongation to break percentage relative to other compositions of PAEK (e.g., Victrex® 450G which has a tensile modulus of 4000 MPa at room temperature). In some embodiments, the specialty PAEK has a tensile modulus at room temperature (e.g., °23 C) that is less than or equal to 3,900 MPa, such as being less than or equal to 3,800 MPa, such as being less than or equal to 3,700 MPa, such as being less than or equal to 3,600 MPa, such as being less than or equal to 3,500 MPa, such as being less than or equal to 3400 MPa, such as being less than or equal to 3,300 MPa. In some embodiments, the specialty PAEK has an elongation at break (i.e., ration between the changed length and the length after breakage) greater than 10%, such as being about 20%, such as being about 30%, such as being about 40%, such as about 50%, such as being about 60%. In some embodiments, the specialty PAEK has a flexural modulus at room temperature that is less than or equal to 80 MPa, such as being less than or equal to about 75 MPa, such as being less than or equal to about 70 MPa, such as being less than or equal to about 65 MPa, such as being less than or equal to about 60 MPa, such as being less than or equal to about 55 MPa, such as being less than or equal to about 50 MPa, such as being less than or equal to about 45 MPa, such as being less than or equal to about 40 MPa. In some embodiments, the PAEK has a flexural modulus at room temperature that is between 40 MPa and 80 MPa, such as being about 40 MPa, such as being about 45 MPa, such as being about 50 MPa, such as being about 55 MPa, such as being about 60 MPa, such as being about 65 MPa, such as being about 70 MPa, such as being 75 MPa, such as being about 80 MPa.

In some embodiments, the specialty PAEK may be an unreinforced and unfilled composition of PAEK. In some embodiments, the specialty PAEK may be a filled PAEK, such as having a filler (e.g., glass, carbon, graphite, moly, etc.) to achieve a desired seal quality For example, the PAEK may be filled with one or more materials (e.g., carbon, graphite, moly) to reduce the coefficient of friction, which may also increase the stiffness. The specialty PAEK may maintain a seal in extreme pressure and temperature environments, such as maintaining a seal at pressures upwards of around 25,000 psi or around 30,000 psi and temperatures upwards of around 450° F.

The specialty PAEK is more ductile and less stiff than conventional PAEK (e.g., virgin PEEK) or conventional reinforced or filled PAEK. This lower stiffness advantageously provides a v-seal that may improve contact pressure with the sealing surface. In other words, the specialty PAEK, such as PEEK, has sufficient spring qualities to resist fluid pressure to maintain contact between the v-seal and the surface being sealed against due to the materials natural bias toward a radially expanded state. Additionally, trying to use the stiffer conventional PAEKs to form a v-seal would require thinning the v-seal to achieve desirable spring qualities that undermines the durability and longevity of the v-seal. Thus, specialty PAEK can be used to form a v-seal with satisfactory seal qualities without sacrificing the thickness, and thus durability, of the v-seal.

The specialty PAEK has a higher stiffness than PFAS in addition to having a lower stiffness than conventional PAEK. Specialty PAEK advantageously provides higher contact pressure than the softer (less stiff) PFAS. In other words, forming the v-seals from specialty PAEK provides a v-seal with improved contact pressure, and thus improved seal quality, as compared to both conventional PAEK and PFAS.

One example of unreinforced and unfilled specialty PAEK is Vestakeep® 5000, a PEEK, which exhibits compliant characteristics preferable to generate a seal. More particularly, Vestakeep® 5000G comprises a flexural modulus of 3,300 MPa at room temperature and a tensile modulus of 3500 MPa at room temperature. Vestakeep® 5000G has a Tensile Modulus that is about 13.33% less than Victrex® 450G (unreinforced PEEK) and about 57.77% less than TECAPEEK® CF30 black (carbon reinforced PEEK). Vestakeep® 5000 generally exhibits a 30% elongation before break wherein other configurations of unreinforced PEEK generally exhibits about 5% elongation at break. The characteristics of the Vestakeep® 5000G thereby make it a viable seal material to for the v-rings 200a-c. In some embodiments, the specialty PAEK may be Victrex® 650G, which has a tensile modulus of 3,900 MPa at room temperature and a flexural modulus of 3,600 MPA at room temperature.

According to embodiments of the present disclosure, the back-up rings 214a,b may also be made of a PAEK material, but in a composition or make-up that exhibits increased rigidity and stiffness as compared to the v-rings 200a-c that are v-seals. In such embodiments, the back-up rings 214a,b may each be made of an unreinforced PAEK, such as a unreinforced PEEK (e.g., virgin PEEK), that exhibits a higher tensile modulus and lower elongation to break percentage as compared to the v-rings 200a-c made of the specialty PAEK. In other embodiments, the back-up rings 214a,b may be made of a combination of reinforced or filled PAEK material exhibiting even greater stiffness (e.g., glass fiber filled PAEK material or carbon fiber filled PAEK material).

In some embodiments, not every v-ring 200a-c is a v-seal. Rather, one or more of the v-rings 200a-c may be another back-up ring (v-ring back-up ring) or spacer ring that is formed from similar materials as the back-up ring 214a,b. In other words, the v-rings that are back-up rings or spacer rings are stiffer than the v-seals. For example, the second v-ring 200b may be a chevron shaped (v-shaped) back-up ring while the first v-ring 200a and third v-ring 200c may each be a v-seal formed from the specialty PAEK. In other words, the v-rings 200a-c are alternating v-seals and back-up-rings. The second v-ring 200b, which is formed of a stiffer material than the adjacent first v-ring 200a and third v-ring 200c, facilitates the expansion of the first v-ring 200a and third v-ring 200c to form a seal in response to fluid flow in the A direction.

In some embodiments, the seal assembly 110 may have more than three v-rings 200a-c, and the v-rings 200a-c may alternate between being a v-seal formed of the specialty PAEK and being a V-shaped back-up ring or spacer ring formed from a stiffer PAEK. Each v-seal being interposed and engaged with two back-up rings (e.g., either backup ring 214a,b and a v-ring back-up ring or two v-ring back-up rings). In some embodiments, only one of the v-rings 200a-c is a v-seal formed from the specialty PAEK.

FIG. 2B is a partial, sectional view of another example of the seal assembly 110, according to one or more additional embodiments. Again, the seal assembly 110 may be positionable within the gland 108 (FIG. 1) of the downhole tool 106 (FIG. 1). Similar to the seal assembly 110 of FIG. 2A, the seal assembly 110 of FIG. 2B includes multiple v-rings as well as the back-up rings 214a,b arranged at the opposing ends 202a,b of the seal assembly 110. However, the seal assembly 110 depicted in FIG. 2B is bi-directional and thereby includes a center member 216.

As illustrated, the seal assembly 110 includes first and second sets (e.g., stacks) of v-rings 220a and 220b separated by the center member 216, the first set of v-rings 220a interposing the first back-up ring 214a and the center member 216, and the second set of v-rings 220b interposing the second back-up ring 214b and the center member 216. Each set of v-rings 220a,b includes one or more v-rings similar to the v-rings 200a-c described herein with respect to FIG. 2A. In the illustrated embodiment, each set of v-rings 220a,b includes five v-rings, but could alternatively include more or less than four v-rings.

In some embodiments, each v-ring within a set of v-rings 220a,b may be a v-seal formed from a PAEK material, such as the specialty PAEK. In some embodiments, v-rings within each set of v-rings 220a,b may alternate between a v-seal formed from a PAEK material and a v-shaped back-up ring or spacer ring, such as a v-shaped back-up ring formed from a stiffer PAEK used to form the v-seals. In some embodiments, at least one of the v-rings in each set of the v-rings 220a,b is a v-seal formed from the specialty PAEK.

In the illustrated embodiment, the center member 216 is an energizing spacer formed from a rigid material such as a metal or a hard plastic. The rigid center member 216 acts, in part, as a back-up ring that helps facilitate the retaining each set of v-rings 220a,b between the respective back-up ring 214a,b. The center member 216 may be formed from be a PAEK material that is more rigid (e.g., stiffer) that the v-seals. For example, the center member 216 may be formed from a carbon filled PAEK which is stiffer than the specialty PAEK used to form the v-seals. In embodiments where the center member 216 is made of a rigid material, the center member 216 may further include one or more intersecting holes 218, which permits fluid communication between the exterior side and interior side of the seal assembly 110 (e.g., by way of the clearance gap 112 of FIG. 1) to promote the radial deformation of the v-rings in response to fluid flow.

In other embodiments, the center member 216 may be formed from an elastic material that energizes the v-rings while also forming a seal against the surface of the gland 108 instead of a rigid material. For example, the center member 216 may be formed from an elastomer or a PAEK material. The elastic center member 216 is an element that the v-stacks 220a,b are compressed against that presses against the v-stacks 220a,b since the elastic center member 216 is biased toward an uncompressed state. The elastic center member 216 is suitable for, by example, low pressure gas applications to inhibit or prevent gas from flowing by the seal assembly 110.

As noted above, the seal assembly 110 shown in FIG. 2B is bi-directional. The v-rings in the first set of v-rings 220a positioned between the center member 216 and the first back-up ring 214a are aligned in the opposite direction as compared to the v-rings in the second set of v-rings 220b positioned between the center member 216 and the second back-up ring 214b. As such, fluid 212 flowing in the first direction A may energize the v-seals in the first set of v-rings 220a into sealing engagement with the surfaces of the gland 108 while the v-seals in the second set of v-rings 220b close to allow flow by the v-rings. In contrast, the fluid 212 flowing in the second direction B, energizes the v-seals in the second set of v-rings 220b and closes the v-rings in the first set of v-rings 220a.

FIG. 3 is a partial, sectional view of another example of the seal assembly 110, according to one or more additional embodiments. The seal assembly 110 is shown disposed in the gland 108 formed between tubular members 301, 302 of the downhole tool 106 (FIG. 1).

The seal assembly 110 illustrated in FIG. 3 includes a first stack 320a and a second stack 320b on opposing sides of a central member 316 (e.g., retainer ring). In some embodiments, the central member 316 is axially fixed to the first tubular member 301 by a fastener 303, such as a bolt. Each stack 320a,b includes a back-up ring 321, a first v-ring 322, a second v-ring 323, and a hat ring 324 (e.g., spacer ring, ring member). As shown, a first (bottom) surface of the back-up ring 321 is generally flat and is engaged with the central member 316. A second surface of the back-up ring 321 that is opposite of the first surface defines a groove 341 that receives a peak 342 defined by a first side of the first v-ring 322. The second side of the first v-ring 322 that is opposite of the peak 342 includes a groove 344 that is engaged with a first side 345 of the second v-ring 323. The first side 345 of the second v-ring 323 has a shape configured to facilitate the radial expansion of the first v-ring 322 into engagement with the surface of the first and second tubular members 301, 302. The second v-ring 323 also has a second side 346 opposite of the first side 345 that is engageable with the respective hat ring 324, such as being in direct contact with the respective hat ring 324. The second side 346 is shown as a U-shaped groove formed in the second v-ring 323 that is disposed between flanged portions 323a of the second v-ring 323.

The hat rings 324 are shaped to keep the second side 346 of the second v-ring 323 from contacting the end wall 305 of the gland 108, such as when the first tubular 301 moves axially relative to the second tubular 302. As shown, an end 325 of the hat ring 324 is engaged with the bottom of the groove defined by the second side 346 of the second v-ring 323. A gap 350 is present between the flanged portions 323a and the sides 326 of the hat ring 324.

One or both of the first v-ring 32 and the second v-ring 323 may be a v-seal that is formed from a PAEK material described above. The characteristics of the specialty PAEK, such as the specialty PAEK described above, advantageously provide desirable contact pressure between the v-seal and the surface of the gland 108. The second v-ring 323 has the gap 350 between the sides 326 of the hat ring 324 and the flanged portions 323a. Conventional v-rings engaged with a hat ring include a spring element disposed in the groove of the v-ring to bias the flanged portions outward to maintain a sealing engagement of the v-ring with the sealing surface because the conventional v-rings do not have sufficient stiffness to resist deflection of the flanged portions away from the sealing surface in response to fluid pressure. Forming the second v-ring 323 from the PAEK material allows the spring element to be omitted since the PAEK material has sufficient stiffness so that the flanged portions 323a are maintained in sealing contact with the seal surfaces (e.g., surfaces of the tubular members 301, 302). In other words, the seal assembly 110 shown in FIG. 3 does not have a spring element to bias the second v-ring 323 since the specialty PAEK provides a contact pressure that is comparable to the spring element.

The central member 316 may be formed from a metal or hard plastic. In some embodiments, the central member 316 may be formed from a PAEK material that is stiffer than the PAEK used to form the v-seal (e.g., second v-ring 322). The back-up ring 321 may also be formed from a PAEK that is stiffer than the PAEK used to form the v-seal.

In some embodiments, the v-seals described above consist entirely of the PAEK material, such as the specialty PAEK. In other words, the v-seals may be devoid or substantially devoid of PFAS and PTFE.

In some embodiments, the seal element formed from PAEK (e.g., PAEK seal element) may not have a v-shape and may instead have a different shape suitable to provide the desired seal. For example, a seal element formed from the PAEK material may have a circular shape, such as being an O-ring.

In some embodiments, the PAEK seal elements formed, such as the v-seals, may be used in rotary seal applications to seal against a rotating interface surface. For example, the PAEK seal element may be rotating relative to the surface that the PAEK seal element is sealing against. The PAEK does not impact with debris like PTFE does, which makes a PAEK a desirable material for use in rotary seal applications.

In some embodiments, the v-seal may formed from a material that comprises a first PAEK and the other v-rings in the stack may be formed from a material that comprises a second PAEK that is different than the first PAEK. The material used to form the other v-rings may have different properties (e.g., elongation at break, flexural modulus, tensile modulus) than the material used to form the v-seals, such as being stiffer.

In some embodiments, the v-seal may formed from a material that comprises a first PAEK and the other v-rings in the stack may be formed from a material that also comprises the first PAEK. The material used to form the other v-rings may have different properties (e.g., elongation at break, flexural modulus, tensile modulus) than the material used to form the v-seals, such as being stiffer.

Embodiments disclosed herein include:

A. A seal assembly comprising a first back-up ring, a second ring member, and a plurality of v-rings arranged in a stacked configuration and interposing the first back-up ring and the second ring member. The at least one of the plurality of v-rings being a v-seal formed from a material that comprises a polyarylether ketone (PAEK), the material having a tensile modulus equal to or less than 3,900 MPa at room temperature.

B. A seal assembly comprising a first back-up ring, a second ring member, and a plurality of v-shaped rings arranged in a stacked configuration and interposing the first back-up ring and the second ring member. Each v-shaped ring being formed from a material comprising a polyarylether ketone (PAEK) that is devoid of perfluoroalkyl/polyfluoroalkyl (PFAS).

C. A seal assembly comprising a first back-up ring, a second ring member, and a plurality of v-shaped rings arranged in a stacked configuration and interposing the first back-up ring and the second ring member. Each v-shaped ring being formed from a material comprising a polyarylether ketone (PAEK that is devoid of both perfluoroalkyl/polyfluoroalkyl (PFAS) and polytetrafluoroethylene (PTFE).

Each of embodiments A, B, and C may have one or more of the following additional elements in any combination:

Element 1: further comprising a center member interposing a first set of the plurality of v-rings and a second set of the plurality of v-rings. Element 2: the material has an elongation at break between 40% and 60%. Element 3: the PAEK is a first PAEK, wherein the v-rings includes at least two back-up rings formed from a second PAEK, the v-seal being disposed between and engaged with the two back-up rings formed from the second PAEK. Element 4: the second ring member is a hat ring that is disposed within and in direct contact with a groove of the v-seal. Element 5: all of the plurality of the v-rings are v-seals. Element 6: the PAEK is a polyether ether ketone (PEEK). Element 7: the PAEK is a first PAEK, wherein the second ring member is a second back-up ring, wherein the first and second back-up rings are each formed from a second material comprising a second PAEK. Element 8: the second PAEK comprises a higher flexural modulus relative to the first PAEK. Element 9: further comprising a center member interposing a first set of the plurality of v-rings and a second set of the plurality of v-rings. Element 10: the center member is formed from an elastomer. Element 11: at least one of the v-shaped rings is a v-seal formed from a first PAEK that has a tensile modulus less than or equal to 3,900 MPa at room temperature, and at least two v-shaped rings are back-up rings formed from a second PAEK that has a tensile modulus that is greater than 3,900 MPa at room temperature, and wherein the v-seal is disposed between and engaged with the two back-up rings. Element 12: the second ring member is a hat ring that is disposed within and in direct contact with a groove of one v-shaped ring. Element 13: the PAEK is a polyether ether ketone (PEEK). Element 14: the plurality of v-rings are chevron shaped. Element 15: at least one of the v-shaped rings is a v-seal formed from a first PAEK that has a tensile modulus less than or equal to 3,900 MPa at room temperature, and at least two v-shaped rings are back-up rings formed from a second PAEK that has a tensile modulus that is greater than 3,900 MPa at room temperature, and wherein the v-seal is disposed between and engaged with the two back-up rings. Element 16: the second ring member is a hat ring that is disposed within and in direct contact with a groove of one v-shaped ring. Element 17: the second member is a second back-up ring, wherein the first and second back-up rings are each formed from a material consisting of PAEK. Element 18, wherein the material has a flexural modulus at room temperature between 80 MPa and 40 MPa.

By way of non-limiting example, exemplary combinations applicable to A, B, and C include: Element 7 with Element 8; Element 9 with Element 10.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A seal assembly, comprising:
a first back-up ring;
a ring member; and
a plurality of v-rings arranged in a stacked configuration and interposing the first back-up ring and the ring member, the plurality of v-rings including a first v-ring in direct contact with a second v-ring,
wherein the first and second v-rings are each formed from a material that comprises a polyarylether ketone (PAEK), the material having a tensile modulus equal to or less than 3,900 MPa at room temperature.

2. The seal assembly of claim 1, further comprising a center member interposing a first set of the plurality of v-rings and a second set of the plurality of v-rings.

3. The seal assembly of claim 1, wherein the material has an elongation at break between 40% and 60%.

4. The seal assembly of claim 1, wherein the first v-ring is a v-seal formed from a first PAEK, and wherein the second v-ring is a second back-up ring formed from a second PAEK.

5. The seal assembly of claim 1, wherein the second ring includes a groove including an open end, a closed end, and opposing first and second inner sides extending from the open end to the closed end, and where the ring member is a hat ring extending through the open end and in direct contact with the closed end of the groove and wherein a first gap is present between a first outer side of the hat ring and the first inner side of the groove and a second gap is present between a second outer side of the hat ring and the second inner side of the groove.

6. The seal assembly of claim 1, wherein each v-ring comprises a v-seal formed from the material.

7. The seal assembly of claim 1, wherein the PAEK is a polyether ether ketone (PEEK).

8. The seal assembly of claim 1, wherein the PAEK is a first PAEK, wherein the ring member is a second back-up ring, and wherein the first and second back-up rings are each formed from a second material comprising a second PAEK.

9. The seal assembly of claim 8, wherein the second PAEK comprises a higher flexural modulus relative to the first PAEK.

10. A seal assembly, comprising:
a first back-up ring;
a ring member; and
a plurality of v-shaped rings arranged in a stacked configuration and interposing the first back-up ring and the ring member, each v-shaped ring being formed from a material comprising a polyarylether ketone (PAEK) that is devoid of perfluoroalkyl/polyfluoroalkyl (PFAS),
wherein the plurality of v-shaped rings includes a first v-shaped ring in direct contact with a second v-shaped ring, and the first v-shaped ring having a tensile modulus equal to or less than 3,900 MPa at room temperature.

11. The seal assembly of claim 10, further comprising a center member interposing a first set of the plurality of v-rings and a second set of the plurality of v-rings.

12. (canceled)

13. The seal assembly of claim 10, wherein the first v-shaped ring is a v-seal formed from a first PAEK, and the second v-shaped ring is a second back-up ring formed from a second PAEK that has a tensile modulus that is greater than 3,900 MPa at room temperature.

14. The seal assembly of claim 10, wherein the ring member is a hat ring that is disposed within and in direct contact with a groove of one of the plurality of v-shaped rings.

15. (canceled)

16. A seal assembly, comprising:
a first back-up ring;
a ring member; and
a plurality of v-shaped rings arranged in a stacked configuration and interposing the first back-up ring and the ring member, each v-shaped ring being formed from a material comprising a polyarylether ketone (PAEK) that is devoid of both perfluoroalkyl/polyfluoroalkyl (PFAS) and polytetrafluoroethylene (PTFE),
wherein the plurality of v-shaped rings includes a first v-shaped ring in direct contact with a second v-shaped ring, and the first v-shaped ring having a tensile modulus equal to or less than 3,900 MPa at room temperature.

17. The seal assembly of claim 16, wherein the plurality of v-rings are chevron shaped.

18. The seal assembly of claim 16, wherein the first v-shaped ring is a first v-seal formed from a first PAEK, and the second v-shaped ring is a second back-up ring formed from a second PAEK that has a tensile modulus that is greater than 3,900 MPa at room temperature.

19. The seal assembly of claim 16, wherein the ring member is a hat ring disposed within and in direct contact with a groove of one of the plurality of v-shaped rings.

20. The seal assembly of claim 16, wherein the ring member is a second back-up ring, wherein the first and second back-up rings are each formed from a material consisting of PAEK.

21. The seal assembly of claim 1, wherein the tensile modulus is equal to or less than 3,600 MPa.

22. The seal assembly of claim 1, wherein the tensile modulus is equal to or less than 3,300 MPa.
